(19) United States
(12) Patent Application Publication
(10) Pub. No.: US 2002/0006798 A1
(43) Pub. Date: Jan. 17, 2002

(54) Cellular radio system

(75) Inventors: Peter Jaenecke, Straubenhardt (DE); Hardy Halbauer, Ettlingen (DE); Gabriele Schwoerer, Weil der Stadt (DE); Jurgen Otterbach, Stuttgart (DE); Gunther Jacob, Rutesheim (DE); Karsten Oberle, Mannheim (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/899,280

(22) Filed: Jul. 6, 2001

(30) Foreign Application Priority Data
Jul. 7, 2000 (DE) 100 32 602.1

(51) Int. Cl. H04Q 7/20

(52) U.S. Cl. 455/446; 455/447; 455/442; 455/524

(57) ABSTRACT

The object of the invention is to provide a cellular radio system, in particular a LMDS system wherein the utilization of the transmission capacity is optimized. The cellular radio system is characterized in particular in that each cell contains a base station, that at least one cell is divided into at least two sectors, that each sector comprises one non-overlapping zone and two overlapping zones, and that each base station is suitable to allocate at least one transmission unit (time slot or orthogonal code) simultaneously to at least two different terminals located in different, non-overlapping zones of a cell.

The invention relates to a cellular radio system and a base station for such a cellular radio system.

Cellular radio systems as such are known. An example of a cellular radio system is a so-called LMDS system; LMDS=local multipoint distribution services. A LMDS system is a wireless broadband system and serves for the bidirectional transmission for example of speech, data and internet services. The data rate amounts for example to 8 Mbit/s in both directions. The transmission takes place for example in the frequency range of 20 to 40 GHz. Each cell is controlled by a base station. In a cell a plurality of terminals can communicate simultaneously with the base station. Terminals are permanently installed, i.e. their position is fixed. LMDS systems normally operate with TDM in the direction from the base stations to the terminals and with TDMA in the direction from the terminals to the base stations; TDM=time division multiplex, TDMA=time division multiple access.

In LMDS systems each cell is normally divided into four sectors, each sector covering an angle of 90° such that a total of 360° are covered.

To avoid intercellular interference, by the use of four frequency channels each sector is allocated a different frequency channel. Within a sector time slots are used as transmission units. The terminals located in a sector are allocated time slots on request from the frequency channel assigned for the corresponding sector.

When CDMA is used in the direction from the terminals to the base stations, it would also be obvious to distribute the frequency channels between the sectors; CDMA=code division multiple access. The terminals would be allocated the orthogonal codes in the corresponding frequency channel.

The object of the invention is to provide a cellular radio system wherein the utilization of the transmission capacity is optimised.

This object is achieved by a cellular radio system according to claim 1.

The cellular radio system is characterised in particular in that each cell contains a base station, that at least one cell is divided into at least two sectors, that each sector is allocated the same frequency channel, that each sector comprises one non-overlapping zone and two overlapping zones, and that each base station is suitable to allocate at least one transmission unit simultaneously to at least two different terminals located in different, non-overlapping zones of a cell. The size of the sectors, and the shape and number thereof is fundamentally arbitrary. In particular they can be adapted to the real cell sizes and shapes and to the customer profiles. A decisive advantage is that the internal cell division is independent of the cell division of the adjacent cells. A subsequent change in a cell division can thus take place without affecting the adjacent cells. If for example more subscriber terminals are required within a cell, the number of sectors is simply increased. If for example a medium-size business is acquired as a new customer within a sector, the requirement in this sector increases considerably. The corresponding sector can be divided into two sectors by the additional installation of an antenna at the base station. Conversely, in the case of a reducing requirement, two sectors can be combined to form one, for example by interconnecting two antennae of the base station. This variability is facilitated by the fact that within a cell the same frequency channel is used in all sectors. Especially in densely populated areas this can be of considerable significance. An initially defined topology thus is not binding but can be dynamically and locally adapted to the actual requirement. Additionally, the maximum number of terminals within a cell now is no longer so limited as it is possible to allocate more transmission units by virtue of the larger number of sectors. Due to the introduction of overlapping and non-overlapping zones, a purposive allocation of transmission units can take place. By definition, terminals in a non-overlapping zone of one sector cannot interfere with terminals in non-overlapping zones of other sectors. For this reason at the maximum a K-fold (in the direction from the terminals to the base station) or K/2-fold (in the direction from the base station to the terminals) allocation of a transmission unit within a cell is possible; here K corresponds to the number of sectors of a cell and is a natural number greater than one. A time slot or orthogonal code is provided for example as transmission unit. A time slot can now be multiply allocated within a cell. In the event that four sectors are provided within a cell, four terminals distributed among the non-overlapping zones of the four sectors can simultaneously use one and the same time slot to transmit information such as speech, data or internet services. When LMDS is used as cellular radio system, the terminals are stationary, i.e. their position within a cell is previously known and stored in the base station. In particular it is known whether a terminal is located inside or outside a non-overlapping zone. When a terminal logs onto the base station, the base station determines the position of the terminal from the address of the terminal. The sector is determined and the correlation with a non-overlapping or overlapping zone. If the terminal is located in a non-overlapping zone, it can be allocated one, two or more time slots or orthogonal codes by the base station from the currently unallocated time slots or codes. For an allocation, N time slots or codes are basically available for each sector, where N is a natural number greater than one. Only those time slots or codes which are used by terminals within the same sector and by terminals within the overlapping zones of the adjacent sectors which adjoin the same sector cannot be allocated. Time slots or codes which are used by terminals outside the same sector and outside the overlapping zones of the adjacent sectors which adjoin the same sector can be allocated however.

Regarding the allocation of transmission units to terminals in overlapping zones: Overlapping zones are characterised in that the radio signals of the terminals located therein can radiate into an adjacent sector and in this way can be received by two receiving antennae of the base station. Additionally, radio signals of a base station transmitting antenna of one sector can be received by terminals in a sub-zone of an adjacent sector. If the same time slot or the same code were now allocated to a terminal in an overlapping zone and to a terminal in a correspondingly overlapping zone of the adjacent sector in the direction from the terminals to the base station, the receiving antennae of the two sectors would receive radio signals from both terminals and thus be disturbed. The two terminals would thus interfere with one another in the case of simultaneous transmission. If the same time slot or the same code were now allocated to a terminal in an overlapping zone and a terminal in a correspondingly overlapping zone of the adjacent sector in the direction from the base station to the terminals, both terminals would receive radio signals from the transmitting antennae of both sectors and both terminals would thus again be affected by interference. To avoid these and other disturbances which for example occur when one terminal is situated in an overlapping zone and another terminal is situated in a non-overlapping zone of an adjacent sector, prior to an allocation it is checked in the base station whether a time slot or code to be allocated is already allocated in the adjacent sector. If this is not the case, the corresponding time slot or code is allocated. If however this is the case, another time slot or code is searched for. If the newly found time slot or code is located neither in the sector of the terminal nor in the adjacent sector, it is allocated to the terminal. If no code can be found since all the time slots or codes either in the sector of the terminal or in the adjacent sector are allocated, a redistribution is attempted in that preferably the same time slots or codes are allocated for terminals in non-overlapping zones of different sectors. The non-allocated time slots or codes which remain following the redistribution can then be allocated to the terminal in the overlapping zone. It should be noted that terminals in overlapping zones of non-adjacent sectors can be allocated the same time slots or codes without the occurrence of interference as radio signals from terminals of a sector radiate at the maximum up to the adjacent sector.

Within a cell the same frequency channel is used in all sectors. The frequency channel consists for example of a channel of a specific bandwidth in the frequency range of 20 to 40 GHz. As a result of the same frequency channel, the number of sectors within a cell can be changed arbitrarily without influencing adjacent cells. It is thus possible to subsequently adapt to the current requirement at any time and in a simple manner, even following the installation and commissioning of the cellular radio network. To make the cellular radio network overall less sensitive to interference, in a preferred embodiment of the invention different frequency channels can be used in adjacent cells. For example, four frequency channels are used which are distributed among the cells such that the cells adjacent to any specific cell, which are eight in number in the case of an orthogonal structure and six in number in the case of a honeycomb structure, each operate with a frequency channel different to that of said cell. In this way equalization is achieved in the entire cellular radio network.

In another preferred embodiment of the invention, within a cell all the active terminals are synchronised. After a terminal has logged on to the base station and before the transmission of data, the terminal is synchronised to the base station's clock. All the active terminals are thus synchronised to the same clock. In this way the allocation of transmission units to terminals is simplified. In addition, potential interference is minimised.

Advantageous developments of the invention are disclosed in the dependent claims and the following description.

In the following an exemplary embodiment will be explained with reference to two Figures in which:

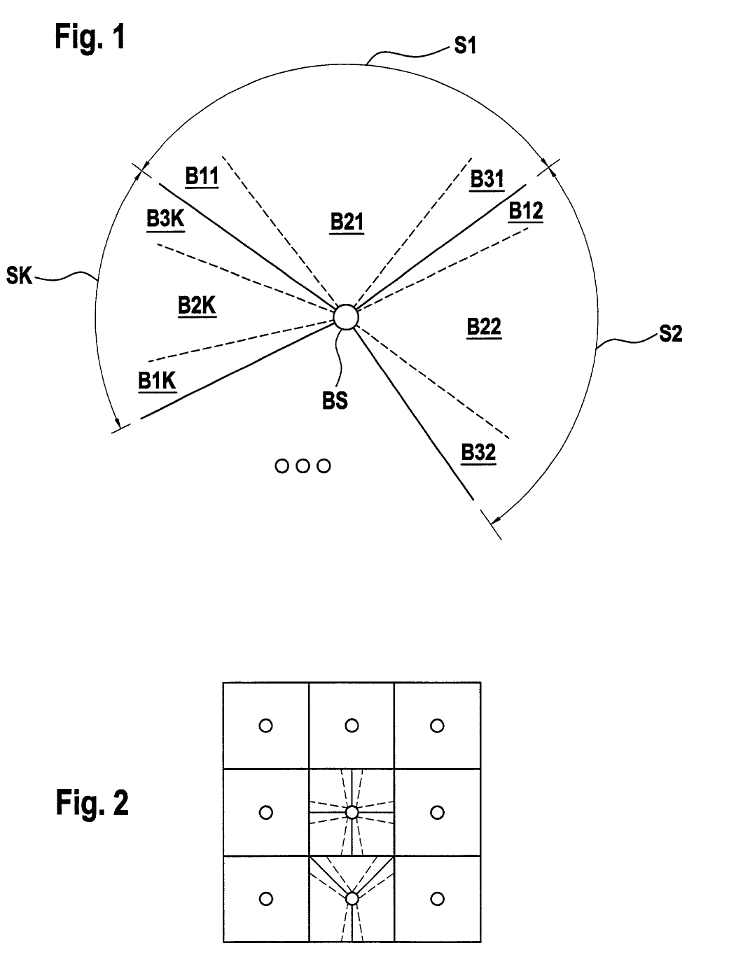

FIG. 1 schematically illustrates a division of a cell into sectors and

FIG. 2 schematically illustrates a topology of a cellular radio network.

The exemplary embodiment will firstly be explained with reference to FIG. 1. FIG. 1 illustrates a division of a cell of a cellular radio network into sectors. The cellular radio network is designed for example as a LMDS system. The radio network is constructed from a plurality of mutually adjacent cells. Each cell has a base station which controls the radio communication within the cell. The base station is generally arranged centrally in the cell. Each cell is divided into a number of sectors, it being possible to vary the number from cell to cell. The size of the cells can likewise vary from cell to cell, for example as a function of the topology of the network. FIG. 1 schematically illustrates a cell having K sectors S1, S2 to SK and a base station BS, where K is a natural number greater than one. Each sector S1, S2 to SK has three zones, one non-overlapping zone and two overlapping zones. Sector S1 comprises the non-overlapping zone B21 and the overlapping zones B11 and B31. Sector S2 comprises the non-overlapping zone B22 and the overlapping zones B12 and B32. Sector SK comprises the non-overlapping zone B2K and the overlapping zones B1K and B3K. The transmitting antennae used in the base station BS to form the sectors S1, S2 to SK have scatter zones in the edge regions, which project into the adjacent sector. This gives rise to the overlapping zones. Terminals situated in the overlapping zones on the one hand can receive radio signals from two different transmitting antennae of the base station. On the other hand the receiving antennae of the base station, which are assigned to the transmitting antennae, receive both radio signals transmitted by a terminal in the overlapping zone. Terminals which on the other hand are located in a non-overlapping zone on the one hand can only receive radio signals from one transmitting antenna of the base station. On the other hand only one receiving antenna of the base station receives radio signals transmitted from the terminal in the non-overlapping zone. Terminals located in a non-overlapping zone thus cannot interfere with terminals located in non-overlapping zones of other sectors. A terminal which on the other hand is located in an overlapping zone can interfere with a terminal located in the adjacent sector adjoining the overlapping zone if it is allocated the same time slot or code as said terminal.

Each sector S1, S2 to SK spans a specific angular range. Each sector S1, S1 to SK can span a different angular range. If for example two sectors are used for a cell, each sector spans an angular range of 180° for example. If for example four sectors are used for a cell, each sector spans an angular range of 90° for example. If for example six sectors are used for a cell, four sectors each span an angular range of 80° for example and two sectors each span an angular range of 20°. The latter sectors are directed for example towards zones in which a higher terminal capacity and/or a higher communication rate exists. Within a sector the non-overlapping zone encompasses approximately 96 to 98% of the sector surface and the two overlapping zones approximately 2 to 4% thereof.

The base station BS contains the usual components, such as a processor, a memory, a number of antennae, coders and decoders, detectors etc. and for example an optical link via optical glass fibre cable to an exchange, a radio link to another base station, or a radio relay link to a control centre.

When TDMA is used, in each cell a number of time slots are used to transmit information from the terminals to the base station. When CDMA is used, in each cell a number of orthogonal codes are used to transmit information from the terminals to the base station.

This will be explained in detail in the following for the situation in which CDMA is used. Similar applies to the transmission of information from the base station to the terminals, taking into account the point-to-multipoint Configuration, for which reason this will not be discussed in detail. In the base station BS for example a maximum number of N orthogonal codes are available at the air interface, where N is a natural number, for example 1000. These codes can now be distributed between terminals in the individual sectors as follows: If those terminals which wish to communicate are all located in the non-overlapping zones, due to the fact that the terminals cannot influence one another, all N codes can be multiply allocated. The N codes are allocated for example to a terminal in sector SI. At the same time m of the N codes are allocated to a first terminal in sector S2 and N-m codes of the N codes are allocated to a second terminal in the sector S2. At the same time for example the N codes are distributed between n terminals in the sector K and allocated thereto. The base station then undertakes the forwarding of the information of all the active terminals of all the sectors, for example via an optical glass fibre line to an exchange, it being possible to employ multiplex techniques for example on the glass fibre line. In LMDS systems it is easy to determine whether the terminals are located in the non-overlapping zones as the terminals are situated at fixed positions which are previously known. The probability that all terminals are located in non-overlapping zones is high as these zones cover by far the largest area of the cell. In the event that a terminal located in an overlapping zone wishes to become active, i.e. to communicate with another terminal via the base station BS, a preprogrammed algorithm is started in the base station. If the terminal is located for example in the zone B31, prior to the allocation of a code it must be checked whether:

1. The code has already been allocated to a terminal in the non-overlapping zone B21 and therefore is in use. Terminals in the zones B21 and B31 lie in the same sector and therefore can interfere with one another.

2. The code has already been allocated to a terminal in the non-overlapping zone B22 and therefore is in use. A terminal in the zone B31 lies in the edge region and therefore can interfere with terminals in the sectors S1 and S2.

3. The code has already been allocated to a terminal in the overlapping zones B11, B31, B12, B32 and therefore is in use.

4. If, due to the allocations specified by 1. to 3., a free code cannot be found, a redistribution of the codes in sectors S1 and S2 can take place in that the number of identical codes in the zones B21 and B22 is maximised as these do not influence one another. Of the 1000 codes, for example preferably the first 900 codes are reserved for the non-overlapping zones and the last 100 codes for the overlapping zones.

A free code X which has been found is then allocated to the terminal in the zone B31. For all the terminals in the sectors S1 and S2 the code X is then in use. However for terminals outside the sectors S1 and S2 this code is freely available and can be simultaneously allocated to another terminal.

A terminal in a non-overlapping zone can thus be allocated the maximum number N of codes. At the same time the N codes are available to the other sectors. A terminal in an overlapping zone can likewise be allocated the maximum number of N codes. At the same time the N codes are available to the other sectors with the exception of the adjacent sector.

Example: A terminal in the zone B31 is allocated N/2 codes from a number of N codes. A terminal in the zone B12 is allocated the remaining N/2 codes. Then no further codes can be allocated in the sectors S1 and S2. However all N codes are freely available to all the other sectors in the direction from the terminals to the base station. In the direction from the base station to the terminals for example the codes allocated in the sector S1 can be reallocated in the sector S3; in the sector S4 the N/2 codes from sector S2 are freely available.

UMTS can also be used in place of a LMDS system as radio system; UMTS=universal mobile telecommunication system or any other cellular radio system. It can be determined by means of the handover function whether a mobile radio device is located in the overlapping zone. The invention is not limited to CDMA. It can also be used in a similar manner in TDMA, FDMA or comparable processes.

The exemplary embodiment will now be explained further with reference to FIG. 2. FIG. 2 illustrates a topology of a cellular radio network. The illustrated extract shows nine cells. One cell is divided into four sectors, another into three sectors. Each sector comprises one non-overlapping zone and two overlapping zones. The number of sectors per cell is a function of the size of the cell, the terrain, the number of terminals, the customer requirements etc. When a LMDS system is used as cellular radio network and the position of the stationary customers prior to the commencement of the installation is also known, in the topology planning it is possible to select the sectors such that the number of terminals in the overlapping zones is minimised, and ideally is zero. In the simplest case the number of sectors for each cell can also be the same for a part of the radio network or for the entire radio network.

In most cases each cell of the cellular radio network is divided into at least two sectors, each sector comprising one non-overlapping zone and two overlapping zones. This will be the case in particular in networks which have a high subscriber density, thus generally in town-centre areas. In exceptional cases sectors can also comprise only one non-overlapping zone, or one non-overlapping zone and only one overlapping zone. This is the case for example when no terminals are present in a specific angular range within a cell and therefore the transmitting- and receiving range need not compulsorily project into this angular range. This can occur particularly in areas with a low subscriber density.

1. A cellular radio system, characterised in that each cell contains a base station, that at least one cell is divided into at least two sectors, that each sector is allocated the same frequency channel, that each sector comprises one non-overlapping zone and two overlapping zones, and that each base station is suitable to allocate at least one transmission unit simultaneously to at least two different terminals located in different, non-overlapping zones of a cell.

2. A cellular radio system according to claim 1, characterised in that each base station of a cell divided into at least two sectors comprises a control unit which is programmed such that a controlled allocation of transmission units to terminals in overlapping zones takes place such that the allocated transmission units are not allocated simultaneously in an adjacent, non-overlapping zone.

3. A cellular radio system according to claim 1, characterised in that time slots or orthogonal codes are used as transmission units.

4. A cellular radio system according to claim 1, characterised in that the sectors of a cell have at least two different sizes and at least two sectors extend over at least two different angles.

5. A cellular radio system according to claim 1, characterised in that the cellular radio system has the form of a LMDS system, and that each cell is divided into four sectors, each sector extending over an angle in the range from 80 to 100°.

6. A cellular radio system according to claim 1, characterised in that the cellular radio system is designed such that within a cell the same frequency channel is used in all sectors.

7. A cellular radio system according to claim 1, characterised in that the cellular radio system is designed such that different frequency channels are used in adjacent cells.

8. A cellular radio system according to claim 1, characterised in that the cellular radio system is designed such that within a cell all the terminals are synchronised.

9. A base station for a cellular radio system, characterised in that the base station serves a cell divided into at least two sectors, each sector being allocated the same frequency channel and each sector comprising one non-overlapping zone and two overlapping zones, and that the base station is suitable to allocate at least one transmission unit simultaneously to at least two different terminals located in different, non-overlapping zones of a cell.

10. A base station according to claim 9, characterised in that the allocation comprises at least one transmission unit for transmitting information from a terminal to the base station and at least one transmission unit for transmitting information from the base station to a terminal.
